(19) United States
(12) Patent Application Publication
(10) Pub. No.: US 2010/0147338 A1
(43) Pub. Date: Jun. 17, 2010

(54) Dishwasher, in Particular Domestic Dishwasher with a Controllable Operation Display Panel

(76) Inventors: Johannes Büsing, Emersacker (DE); Daniel Delle, Bachingen (DE); Gerhard Fetzer, Gundelfingen (DE); Peter Geissler, Holzheim (DE); Norbert Gerstner, Heidenheim (DE); Hubert Groll, Modingen (DE); Mathias Herrmann, Dischingen (DE); Dieter Hotz, Dischingen (DE); Stefan Kasbauer, Dillingen (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(21) Appl. No.: 12/083,182

(22) PCT Filed: Oct. 4, 2006
(86) PCT No.: PCT/EP2006/067027

§ 371 Date: Apr. 3, 2008

(30) Foreign Application Priority Data
Oct. 6, 2005 (DE) 10 2005 047 914.6

(51) Int. Cl. B08B 3/00

(52) U.S. Cl. 134/56 D; 340/603

(57) ABSTRACT

A dishwasher with a controllable operation display panel, has a plurality of illumination elements for emitting light rays. When a medium necessary for normal operation of the dishwasher is lacking, some or all the illumination elements of the operation display panel can be intermittently activated.

The invention relates to a dishwasher, in particular a domestic dishwasher, having a controllable status display which comprises one or more illumination elements for emitting light beams.

Various domestic appliances are known, the entire front face of which is provided with an appliance front panel which can be matched to surrounding furniture fronts. Domestic appliances of this kind include e.g. cookers, refrigerating appliances and dishwashers. With a domestic appliance which can be fully integrated there is the problem that a visual status display is hidden by the appliance front panel when a front door of the fully integratable domestic appliance is closed, with the result that the operating status of the fully integratable domestic appliance cannot be checked.

DE 100 22 206 C2 contains a description of a built-in dishwasher having a hinged appliance door which on its upper front surface has a visual operating status display comprising one or more light sources which, when the appliance door is closed, are covered by a countertop resting on the top of the dishwasher. There, a light guide is connected to a vapor protection element which is fixed in position on the underside of the countertop above the appliance door and which guides the signal light of the covered visual operating status display to the front of the appliance. The disadvantage is that the signal light in the light guide is difficult for a user standing in front of the built-in domestic appliance or dishwasher to see because the light guide is situated in a gap between the countertop underside and the appliance door edge and is covered by the countertop from above. In particular when a very thick appliance front panel is used, detecting the signal light is made more difficult, since in this way the light guide is additionally covered from below by the appliance front panel.

In order to improve the visibility of the signal light of at least one visual operating status display, DE 102 59 764 A1 proposes embodying the light guide in such a way that its light guide path can be adjusted to match the thickness of the covering element. For this purpose the light guide can be displaceable relative to the visual status display. What is disadvantageous in this arrangement is that the light coupled out from the light guide can vary depending on the position relative to the light source, so that under certain conditions the visibility of the operating status display is impaired.

DE 103 03 354 A1 discloses a light fitting having light-emitting diodes arranged in series, wherein the light fitting is embodied as a countertop edge piece, in particular as a kitchen countertop edge piece, on the underside of which the light-emitting diodes are arranged. The light fitting can also be embodied as a profile strip which is fixed in the plinth return of one or more cabinets, in particular kitchen base cabinets. The purpose is to achieve good illumination of the floor and, in the case of the countertop edge piece, to illuminate the fronts of the cabinets and in addition to illuminate drawers or other built-in parts.

In order to ascertain the current status of an executing program without great effort during the operation of the domestic appliance and without compromising or interrupting the operation of the domestic appliance, DE 101 44 668 proposes an operational sequence display in the form of a light strip for a washing machine, which light strip consists of a relatively large number of lighting elements, with an increasing number of light elements of the light strip lighting up as the execution of the wash program progresses or as the rotational speed of the wash drum increases.

Also known from DE 10 2004 019 329.0 of the applicant is a controllable operating cycle display having a number of illumination elements, wherein the light intensity of the individual illumination elements is controlled as a function of the operation of the dishwasher. The illumination elements of the operating cycle display are arranged in a side area of the dishwasher or in the edge of a front door of the dishwasher, with the light beams generated by the illumination elements being able to be emitted at least partially indirectly. The arrangement of the illumination elements in the side area of the dishwasher results in the gaps between the dishwasher and the adjacent cabinet components or domestic appliances being illuminated when the illumination elements light up. Accordingly, when the illumination elements light up, the outlines of the dishwasher are recognizable according to the progress of the program execution.

It is the object of the present invention to create a dishwasher having a status display which further develops the arrangements known from the prior art, wherein in particular a good visibility of the status display is to be ensured.

This object is achieved by means of the inventive dishwasher having the features according to claim 1. Advantageous developments will be apparent from the dependent claims.

In a dishwasher according to the invention, an intermittent operation of a number or all of the illumination elements of a controllable status display can be initiated in the event of a lack of an additive agent that is necessary for the normal operation of the dishwasher.

In this way it is possible to indicate the lack of an additive agent necessary for the operation of the dishwasher to the user in an easily recognizable way. The intermittent operation of the illumination elements prompts greater attentiveness on the part of the user compared with a status display which signals the lack of an additive agent using an essentially uniform radiation of light. Furthermore the intermittent operation of the illumination elements brings with it the advantage that the energy consumption of the status display is reduced owing to the merely momentary emission of light.

In a preferred embodiment of the present invention the status display also serves to signal an operating sequence or a malfunction of the dishwasher, the light intensity of the illumination elements in the case of a lack of the additive agent differing from the light intensity of the operating sequence or malfunction. By this means, in addition to the intermittent operation, the user is given a simple means of distinguishing whether a lack of an additive agent that is necessary for the normal operation of the dishwasher is present or whether another operating status, e.g. corresponding to the progress of a program execution, is being indicated.

According to a further embodiment of the invention the dishwasher is operated in normal operation with at least two additive agents and the frequency of the intermittent operation of the illumination elements is controllable as a function of the type of the missing additive agent. With the aid of different flashing patterns or different flashing frequencies it is made possible for the user to distinguish easily which additive agent is required for further operation.

According to a further embodiment the status display is formed by means of the connection in parallel of at least two element branches, each of which has a number of illumination elements and which for the purpose of their activation can each be connected to an energy source by means of a controllable switching element. By this means it is easily possible to arrange the element branches and therefore the status display formed by the illumination elements in a distributed manner over the dishwasher in order to make the status more readily recognizable, and to effect control in a simple manner by actuating the switching elements, e.g. intermittently. The illumination elements can in principle consist of any lighting means, light-emitting diodes (in any number and interconnection arrangement) or ends of light guides connected to light sources being particularly suitable on account of the free choice of color and their easy controllability. As is well known, light-emitting diodes have the property that the light radiation emitted by them varies with the current flowing through them.

In conjunction with an embodiment in which a specified current is supplied by the energy source, irrespective of how many of the element branches are conductively connected to the energy source, it is easily possible to set the light intensity of the individual element branches in an intermittent mode of operation. According to this variant the energy source can be embodied as a constant current source. If, for instance, at least one of the element branches is separated from the energy source, a bigger current can be made available to the further element branches connected to the energy source, as a result of which a more intense light pattern is generated in said element branches.

According to a further embodiment the status display has illumination elements with different colors, preferably with each color symbolizing a different display function. Thus, for example, the lack of a particular additive agent could be signaled by a specific color and the lack of a different additive agent by another color. According to a further embodiment the illumination elements can be embodied for emitting light beams of different colors.

If the display's intermittent light pattern, which signals the lack of an additive agent in particular by flashing, is supplemented according to a further embodiment by the controllability of the light intensity of the individual illumination elements as a function of an operating status of the domestic appliance, then the status display can also be used for signaling an operating sequence or other states (e.g. ON or OFF).

Illumination elements of the status display which are arranged on different sides of the dishwasher are preferably operated in an intermittent mode of operation. This can be realized by arranging corresponding element branches on respective sides of the dishwasher. As a result of the physical distance between the illumination elements arranged on different sides of the dishwasher the intermittent operation of the status display can be recognized particularly clearly. In particular an intermittent illumination of the gap formed between the dishwasher and the adjacent cabinet components can be effected in this case.

The illumination elements of the status display are preferably arranged in a side area of the dishwasher. This arrangement brings with it the special visual effect that when illumination elements light up, the outlines of the dishwasher are at least partially illuminated. The illumination elements of the status display can be arranged in the side of a cover forming the front of the dishwasher. In addition or alternatively the illumination elements of the operating status display can also be arranged in the edge of a front door of the dishwasher. In particular in the case of dishwashers which are integrated for example as built-under appliances between further domestic appliances or other cabinet components in a row of kitchen units, the arrangement of the illumination elements in the side area of the dishwasher affords the visual effect that the gaps between the dishwasher and the adjacent cabinet components or domestic appliances are illuminated more uniformly when illumination elements light up.

The dishwasher according to the invention can be a fully integrated dishwasher or a drawer-type dishwasher.

The present invention will be explained in more detail below with the aid of an exemplary embodiment and with reference to the attached drawings, in which:

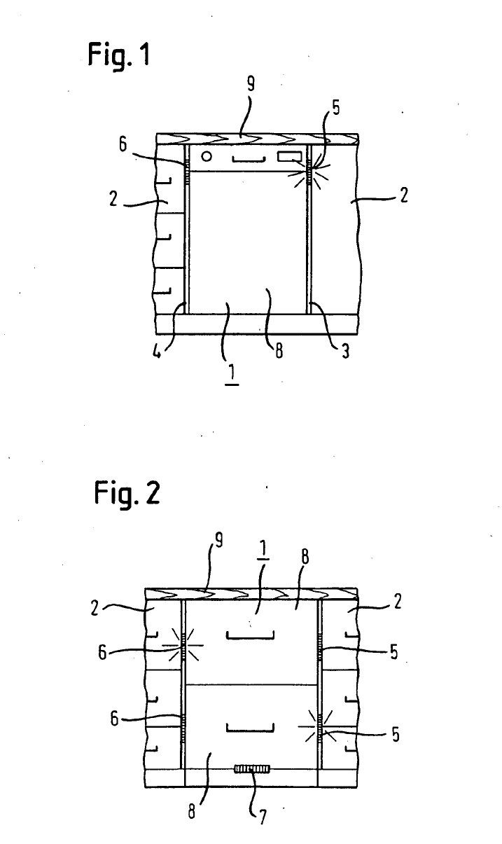

FIG. 1 shows a partial front view of a row of kitchen units in which a dishwasher is integrated in a first embodiment with a status display according to the present invention,

FIG. 2 shows a partial front view of a row of kitchen units in which a dishwasher is integrated in a second embodiment with a status display according to the present invention, and

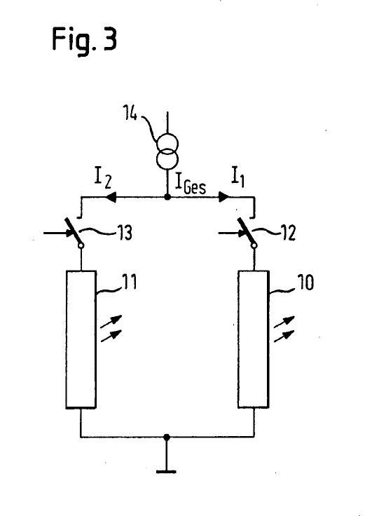

FIG. 3 shows a schematic equivalent circuit diagram of a status display for use in a dishwasher according to the invention, which equivalent circuit diagram clarifies the electrical interconnection.

FIG. 1 shows a partial front view of a row of kitchen units in which an inventive dishwasher 1 having a status display is integrated, and which is covered by a countertop 9. Adjacent to the dishwasher 1 are cabinet components or domestic appliances 2, a gap 3 and 4 remaining in each case between a front door 8 of the dishwasher 1 and the adjacent cabinet components or the domestic appliances 2.

According to this exemplary embodiment the status display of the dishwasher 1 is formed by means of two illumination elements 5 and 6 in the upper area of the dishwasher 1 which are arranged simply by way of example in a side area of the dishwasher 1 and/or in a side of the front door 8 forming the front of the dishwasher 1. With regard to an arrangement embodied in this way reference is made to the German patent specification DE 10 2004 019 329.0 of the applicant, the contents of which, insofar as relevant, are incorporated in the present description.

According to an alternative embodiment (not shown) a plurality of illumination elements could also be disposed in a distributed arrangement over the entire length of the gaps 3, 4. The illumination elements can be controllable individually by means of the program control. They can also be electrically interconnected (in any way) and be collectively controllable at least partially. Preferably at least those illumination elements which are arranged for illuminating a common gap are interconnected.

According to a further arrangement, likewise not shown, the illumination elements can alternatively or also in addition be arranged in the area of the front door 8 that is visible from the front.

The status display is controlled by means of an electronic program control (not shown) of the dishwasher 1, the program control controlling the light mode. In order to signal the lack of an additive agent, such as e.g. a detergent substance, rinsing agent, water softener etc., the illumination elements 5 and 6 are operated intermittently, which is to say at a predetermined flashing frequency, such that the illumination element 5 in the right-hand gap 3 and the illumination element 6 in the left-hand gap 4 light up alternately. In this case the flashing frequency can be controlled differently as a function of the type of a missing additive agent.

By corresponding arrangement of the illumination elements 5, 6, according to the embodiment shown the gaps 3, 4 are at least partially illuminated when the illumination elements 5, 6 light up. Arranging the illumination elements 5, 6 on the opposite sides of the dishwasher 1 and activating them alternately provides the user with a particularly readily perceptible signaling of a lack of an operating resource.

The status display shown in FIG. 1 can be formed for example by the connection in parallel of at least two element branches 10, 11, each of which has a number of illumination elements and which for the purpose of their activation can each be connected to an energy source 14, e.g. a constant current source for delivering a current I_{Ges} (FIG. 3), by means of a controllable switching element 12, 13. If both switching elements 12, 13 are closed, the total current I_{Ges} divides itself into two equal-sized currents I₁ and I₂, provided the element branches 10, 11 have identical resistances. If, for the purpose of implementing a flashing mode of operation of the status display, the one switching element 12 is alternately closed while the other switching element 13 is open, and vice versa, then the total current I_{Ges} flows through the element branch 10 and in the reverse switch position the total current I_{Ges} flows through the element branch 11. By means of this simple circuit arrangement a bigger current can be made available to a respective element branch, as a result of which the light radiation generated by the element branch is more intense compared with a mode of operation in which both element branches emit light radiation.

FIG. 2 shows a partial front view of a row of kitchen units in which there is arranged between adjacent cabinet components 2 a dishwasher embodied as a drawer-type dishwasher having an operating status display of the above-described type. Provided in addition to the illumination elements 5, 6 at least partially illuminating the gaps 3, 4 is a further illumination element 7 which is arranged in the lower area of the front door 8 and causes the floor to be illuminated.

The status display according to the invention can additionally be used to indicate whether the dishwasher is in operation or not. During its operation, all of the illumination elements can be in operation, for example. Conversely, if the dishwasher is not in operation, there is no illumination of the gaps and/or of the floor.

By means of the flashing mode of operation of the status display, supplemented where appropriate by a different color scheme, it is possible to achieve a particularly good means of recognizing an operating status of the dishwasher indicating a lack of a resource.

The status display can be implemented in a dishwasher in addition to conventional operating status displays, e.g. in the area of a front panel of the front door, or also independently.

### LIST OF REFERENCE SIGNS

1 Dishwasher
2 Adjacent cabinet component or domestic appliance
3 Gap
4 Gap
5 Illumination element
6 Illumination element
7 Illumination element
8 Front door
9 Countertop
10 Element branch
11 Element branch
12 Switching element
13 Switching element
14 Energy source
15 I_{Ges} Current
I₁ Current

1-14. (canceled)

15. A dishwasher comprising:
a status display; and
a controller that controls the status display to illuminate in response to a lack of an additive agent for an operation of the dishwasher.

16. The dishwasher of claim 15, wherein the controller controls the status display to illuminate at a different intensity for an operating sequence or a malfunction of the dishwasher than for the illumination in response to a lack of additive agent.

17. The dishwasher of claim 15, wherein the controller controls the status display to illuminate with a different sequence or frequency of an intermittent operation in response to a lack of a corresponding one of a plurality of additive agents.

18. The dishwasher of claim 15, wherein the status display comprises:
a plurality of parallel connected element branches each having an illumination element; and
a switch that controllably connects an energy source to the illumination elements.

19. The dishwasher of claim 18, wherein the energy source delivers a predetermined current to each of the illumination elements irrespective of the number of illumination elements connected to the energy source.

20. The dishwasher of claim 15, wherein the status display comprises a plurality of illumination elements each having a color that corresponds to a different display function.

21. The dishwasher of claim 15, wherein the status display comprises illumination elements that emit light beams of different colors.

22. The dishwasher of claim 15, wherein the controller controls a light intensity of the status display based upon an operating status of the dishwasher.

23. The dishwasher of claim 15, wherein the status display comprises illumination elements arranged on different sides of the dishwasher.

24. The dishwasher of claim 15, wherein the controller controls the status display to illuminate in an intermittent mode.

25. The dishwasher of claim 15, wherein the status display comprises an illumination element in a side area of the dishwasher.

26. The dishwasher of claim 15, further comprising a front door and wherein the status display includes an illumination element on the front door.

27. The dishwasher of claim 26, wherein the illumination element on a side of the front door.

28. The dishwasher of claim 26, wherein the illumination element is on an edge of the front door.

29. The dishwasher of claim 15, wherein the dishwasher comprises a fully integrated dishwasher.

30. The dishwasher of claim 15, wherein the dishwasher comprises a drawer-type dishwasher.
